(19) United States
(12) Patent Application Publication
(10) Pub. No.: US 2015/0352498 A1
(43) Pub. Date: Dec. 10, 2015

(54) PROCESS AND SYSTEM FOR PRODUCING SODIUM CHLORIDE BRINE

(71) Applicant: Ahilan RAMAN, Dandenong (AU)

(72) Inventor: Ahilan RAMAN, Dandenong (AU)

(21) Appl. No.: 14/422,161

(22) PCT Filed: Aug. 16, 2012
(86) PCT No.: PCT/AU2012/000965

§ 371 Date: Aug. 28, 2015

Related U.S. Application Data
(60) Provisional application No. 61/673,494, filed on Jul. 19, 2012.
(60) Provisional application No. 61/524,663, filed on Aug. 17, 2011.

(51) Int. Cl. B01D 61/58; C25B 15/08; C25B 1/14; C25B 1/46; C25B 9/08

(52) U.S. Cl. CPC B01D 61/58; C25B 1/46; C25B 9/08; C25B 1/14; C25B 15/08; B01D 61/025

(57) ABSTRACT

The invention provides a process and system for producing sodium chloride brine suitable for use in a sodium hydroxide production plant having a chlor-alkali membrane cell, said process comprising (a) nanofiltering feed water containing dissolved sodium chloride to produce a permeate and a retentate, wherein the retentate comprises at least 85% of any divalent ions from the feed water; and (b) purifying the permeate to produce the sodium chloride brine suitable for use in a sodium hydroxide production plant having a chlor-alkali membrane cell, wherein step (b) comprises electrodialyzing the permeate to produce a concentrate having a greater concentration of total dissolved salts and a smaller proportion of divalent ions than the permeate and a diluent comprising water and divalent ions separated from the permeate. The invention also provides a process and system for producing sodium hydroxide, and a process for the commercial production of soda ash.

### BACKGROUND

1. Technical Field

The present invention relates a process and a system for producing sodium chloride brine, and a process and system for producing sodium hydroxide or sodium carbonate from the brine.

2. Description of the Related Art

Sodium chloride brine is used for the production of sodium hydroxide, and there are three basic chlor-alkali process cells used to produce sodium hydroxide from brine: the mercury cell, the diaphragm cell and the membrane cell. While membrane cells offer significant advantages over mercury cells and diaphragm cells, namely cell efficiency, power consumption, quality of products, and overall economics; these membrane cells require much purer brine than their predecessors. In particular, brine with low magnesium, calcium and sulfate contents is required.

In order to produce a brine of suitable quality, sodium hydroxide producers often form a raw brine using bulk crude salt. The raw brine is then purified to produce sodium chloride brine suitable for being electrolyzed in the chlor-alkali membrane cell to produce sodium hydroxide.

Crude salt will often contain a combination of different minerals in addition to sodium chloride. These minerals may include anhydrite (CaSO₄), aragonite (CaCO₃), arcanite (K₂SO₄), bischofite (MgCl₂.6H₂O), bloedite (Na₂SO₄.MgSO₄.4H₂O), borax (Na₂B₄O₇.10H₂O), burkeite (Na₂CO₃.Na₂SO₄), calcite (CaCO₃), carnallite (MgCl₂.KCl.6H₂O), colemanite (Ca₂B₆O₁₁.5H₂O), dolomite (CaMg(CO₃)₂), epsomite (MgSO₄.7H₂O), gaylusite (Na₂CO₃.CaCO₃.5H₂O), glaserite (3K₂SO₄.Na₂SO₄), gypsum (CaSO₄.2H₂O), hexahydrate (MgSO₄.6H₂O), hydrophilite (CaCl₂), kainite (4KCl.4MgSO₄.11H₂O), kieserite (MgSO₄.H₂O), kernite (Na₂B₄O₇.4H₂O), langbeinite (K₂SO₄.2MgSO₄), leonite (K₂SO₄.MgSO₄.4H₂O), loweite (Na₂SO₄.MgSO₄.2.5H₂O), magnesite (MgCO₃), mirabilite (Glauberite) (Na₂SO₄.10H₂O), nahcolite (NaHCO₃), niter (KNO₃), polyhalite (K₂SO₄.MgSO₄.2CaSO₄.2H₂O), pinsonite (Na₂CO₃.CaCO₃.2H₂O), schoenite (K₂SO₄.MgSO₄.6H₂O), sylvinite (KCl+NaCl), sylvite (KCl), syngenite (K₂SO₄.CaSO₄.H₂O), tachyhdrite (CaCl₂.2MgCl₂.12H₂O), thenardite (Na₂SO₄), trona (Na₂CO₃.NaHCO₃.2H₂O), ulexite (NaCaB₅O₉.8H₂O), and vanthoffite (3Na₂SO₄.MgSO₄).

Crude salt can be produced by solar evaporation of seawater, brine prepared from rock salts, naturally occurring brines, or saline water obtained in coal mines or other sources. Solar evaporation to produce salt has been practiced for many centuries and typically involves the following steps: concentration of the salt-containing water, crystallization of the salts, harvesting of the salts, washing to meet market specifications, and stockpiling to drain and dewater. Crude salt produced using solar evaporation is generally known as solar salt. Solar salt is typically 90 to 94% sodium chloride, but this can vary depending upon the composition of the starting materials.

As an alternative to solar evaporation, water from seawater or other saline waters may be evaporated using single or multiple-effect evaporators, including thermal or mechanical vapor recompression evaporators, to produce crude salt. Multiple-effect systems typically contain three or more forced-circulation evaporating vessels connected in series. The steam produced in each evaporator is fed to the next one in the multiple-effect system to increase energy efficiency. Mechanical vapor recompression forced-circulation evaporators comprise a crystallizer, a compressor, and a vapor scrubber. The brine enters the crystallizer vessel, where salt is crystallized. Vapor is withdrawn, scrubbed, and compressed for reuse in the heater.

The raw brine produced from crude salt is passed through a brine purification process to produce sodium chloride brine suitable for use in a chlor-alkali membrane cell. The purification process may include chemical precipitation of calcium, magnesium and sulfate impurities, filtration of the precipitates, and ion exchange to reduce the levels of calcium, magnesium and sulfate species further.

In order to ensure that the brine is of sufficient purity, the reagents used for chemical precipitation of impurities may be provided in excess of the stoichiometric ratio. That is, the chemical reagents may be overdosed. For example, sulfate precipitation with calcium chloride often requires overdosing of calcium chloride and an extended reaction time before gypsum (CaSO₄.2H₂O) crystals form.

Calcium from the crude salt and also from the calcium chloride overdosing is removed in a secondary process step through precipitation following the addition of sodium carbonate (Na₂CO₃).

Magnesium is precipitated from the raw brine through the addition of sodium hydroxide (NaOH).

The brine resulting from the overdosing of sodium carbonate and sodium hydroxide is alkaline. The pH of the treated brine is generally corrected through the addition of hydrochloric acid.

Maintaining the correct dosage of reagents is vital for efficient brine purification using chemical precipitation. If the dosage of reagent is too low, impurities will not be removed, allowing them to enter the membrane cell and damage membranes. On the other hand, if too much reagent is used, excess reagent is wasted and the levels of hydrochloric acid required to correct brine pH are too high. Excessive reagent consumption can be costly and affect the economic efficiency of sodium chloride production. Accordingly, it may be desirable to minimize or avoid the use of chemical precipitation to produce a sodium chloride brine use in a chlor-alkali membrane cell.

An opportunity therefore remains to address or ameliorate one or more shortcomings or disadvantages associated with existing means for producing sodium chloride brine and/or to at least provide a useful alternative thereto.

### BRIEF SUMMARY

The present invention provides a process for producing sodium chloride brine suitable for use in a sodium hydroxide production plant having a chlor-alkali membrane cell, said process comprising:

a) nanofiltering feed water containing dissolved sodium chloride to produce a permeate and a retentate, wherein the retentate comprises at least 85% of any divalent ions from the feed water; and

b) purifying the permeate to produce the sodium chloride brine suitable for use in a sodium hydroxide production plant having a chlor-alkali membrane cell, wherein step b) comprises electrodialyzing the permeate to produce a concentrate having a greater concentration of total dissolved salts and a smaller proportion of divalent ions than the permeate and a diluent comprising water and divalent ions separated from the permeate.

Producing a sodium chloride brine in accordance with the present invention can enable water resources to be utilized more efficiently than conventional methods of preparing sodium chloride brines for sodium hydroxide production. In particular, the present invention converts feed water into a brine without first evaporating all the water from the feed water to produce bulk crude salt and then reconstituting the crude salt into a raw brine. That being said, even in embodiments where the feed water is raw brine, the present invention may facilitate recovery of water from the raw brine. For example, electrodialysis of the nanofiltration permeate forms a concentrate, which may be a sodium chloride brine suitable for use in a chlor-alkali membrane cell, and a diluent having reduced total dissolved salts relative to the feed water. The diluent may constitute over 95% of the volume of the nanofiltration permeate and can be treated using conventional desalination techniques to recover about 75% of its volume as potable water.

When sodium chloride brine is for use in a chlor-alkali membrane cell, the divalent ion impurities of particular significance are magnesium, calcium and sulfate ions. In chlor-alkali membrane cells, magnesium causes hydrogen evolution at the anode. Chlorine is typically formed during the process can combine with the evolved hydrogen to create an explosive mixture. Thus, the removal of magnesium ions from the brine is important for the safe production of sodium hydroxide. High concentrations of sulfate ions can cause premature failure of the membranes, both mechanically and in their separation performance. Calcium can accumulate on membranes forming scale. Periodical scale removal is costly and leads to production losses.

As at least 85% of any divalent ions from the feed water are separated into the nanofiltration retentate, the retentate may be further processed to recover valuable products. For example, magnesium may be recovered from the retentate.

In some embodiments, the process of the present invention may be implemented so that there is no, or very little, liquid waste discharged. Instead, water from the nanofiltration retentate and the electrodialysis diluent may be converted into potable water using conventional desalination techniques or otherwise recycled back into the process. Any mineral rich stream produced following desalination of the retentate or diluent may also be passed on to mineral recovery stages or recycled. For example, if the mineral rich stream has a high divalent ion content then it may be directed to processes for recovering magnesium or calcium. If the mineral rich stream predominantly contains dissolved sodium chloride, then it may be desirable to recycle this steam into the feed water or the nanofiltration permeate. In certain embodiments, the electrodialysis diluent may be recycled via a reverse osmosis treatment stage in which potable water and a reverse osmosis retentate is produced and the retentate is recycled into the feed water in order to produce brine having about 200 ppm or less divalent ions. Thus, through the staged nanofiltration and electrodialysis processes of the present invention, it may be possible to maximize the recovery of potable water, sodium chloride brine and other mineral products from the feed water.

The process of the present invention produces sodium chloride brine suitable for use in a sodium hydroxide production plant having a chlor-alkali membrane cell. That is, the sodium chloride brine may be suitable for feeding into the plant via existing purification systems in the sodium hydroxide production plant, such as chemical precipitation and ion exchange. Sodium chloride brines “suitable for use in a sodium hydroxide production plant having a chlor-alkali membrane cell” also include brines having sufficient purity for direct use the chlor-alkali membrane cell. Such brines typically have a divalent ion content of about 250 ppm or less, and at least 180,000 ppm, for example at least 190,000 ppm, total dissolved salts so that they can be fed directly to the chlor-alkali membrane cell for electrolysis. Thus, some embodiments of the inventive process may eliminate the need to conduct any chemical precipitation or ion exchange in order to product brine with sufficient purity for use in a chlor-alkali membrane cell.

In some embodiments, the feed water comprises a stream supplied from a later stage of the inventive process. For example, the process of the present invention may comprise:

a) nanofiltering feed water containing dissolved sodium chloride to produce a permeate and a retentate, wherein the retentate comprises at least 85% of any divalent ions from the feed water; and

b) purifying the permeate to produce the sodium chloride brine suitable for use in a sodium hydroxide production plant having a chlor-alkali membrane cell, wherein step b) comprises:

electrodialyzing the permeate to produce a concentrate having a greater concentration of total dissolved salts and a smaller proportion of divalent ions than the permeate and a diluent comprising water and divalent ions separated from the permeate;

treating the diluent using reverse osmosis to produce a reverse osmosis retentate; and

supplying at least part of the reverse osmosis retentate to step a). The reverse osmosis retentate may be supplied so that it makes up at least part of the feed water. In some of these embodiments, the concentrate may be a sodium chloride brine suitable for direct use in the chlor-alkali membrane cell. Thus, the electrodialysis concentrate may be sodium chloride brine having at least 180,000 ppm, for example at least 190,000 ppm, total dissolved salts and less than 250 ppm divalent ions. For example, the brine may have more than 300,000 ppm total dissolved salts.

Alternatively, the process of the present invention may be operated so that all of the feed water is made up of the supplied reverse osmosis retentate. In these embodiments, the electrodialysis concentrate may be sodium chloride brine at least 180,000 ppm, for example at least 190,000 ppm, preferably more than 300,000 ppm, total dissolved salts and less than 50 ppm divalent ions, preferably less than 1 ppm divalent ions, more preferably less than 100 ppb divalent ions and even more preferably less than 20 ppb divalent ions.

In these embodiments, “supplying” includes recycling or returning the reverse osmosis retentate to the same nanofiltration unit that was used in the iteration of the process that produced that reverse osmosis retentate. “Supplying” also includes transferring the reverse osmosis retentate to another system for implementing the inventive process that is arranged in series. Accordingly, when the process of the present invention is operated so that all of the feed water is made up of supplied reverse osmosis retentate, it may be operated in a batch-wise manner or it may utilize two or more systems for implementing the process in series to enable continuous production of a sodium chloride brine using the reverse osmosis retentate as feed water.

In addition to producing a reverse osmosis retentate, subjecting the diluent to reverse osmosis produces a reverse osmosis permeate. The reverse osmosis permeate may be potable water.

Further purification may be required to produce sodium chloride brine suitable for direct use in the chlor-alkali membrane cells itself. This further purification may be performed by feeding brine suitable for use in a sodium hydroxide production plant having a chlor-alkali membrane cell into existing purification systems of the sodium hydroxide production plant. Alternatively, the process of the present invention may include further purification steps. In these embodiments, purifying may further comprise subjecting the electrodialysis concentrate to chemical precipitation treatment to produce the sodium chloride brine. In some embodiments, the concentrate is subjected to an ion exchange treatment after the chemical precipitation treatment to produce the sodium chloride brine. In some other embodiments, the electrodialysis concentrate may be subjected to ion exchange treatment without first undergoing chemical precipitation treatment. In some of those embodiments, a sodium chloride brine having 20 ppb or less divalent ions is produced by subjecting a concentrate having up to 200 ppm divalent ions to ion exchange treatment. Accordingly, when the electrodialysis concentrate has more than 200 ppm divalent ions, it may subjected to chemical precipitation treatment followed by ion exchange in order to produce a sodium chloride brine suitable for direct use the chlor-alkali membrane cell, preferably a brine having less than 20 ppb divalent ions.

It will be appreciated that, when chemical precipitation treatment and/or ion exchange treatment is performed, the concentration of impurities in the electrodialysis concentrate is nevertheless significantly reduced compared to the concentration of impurities in the feed water. Accordingly, fewer impurities must be removed by chemical precipitation or ion exchange, which may have cost benefits. For example, smaller quantities of reagents will be required for chemical precipitation. Also, due to the reduced levels of impurities, ion exchange resins can be used for longer periods of time before regeneration is necessary.

In some embodiments, the sodium chloride brine is a saturated sodium chloride brine. That is, it may be a brine having about 300,000 to 315,000 ppm total dissolved salts, subject to operating temperature. In such embodiments, purification may include evaporating the concentrate (optionally after performing chemical precipitation treatment and/or ion exchange treatment) to produce a saturated sodium chloride brine.

The present invention also provides a system for implementing the inventive process. That is, the present invention provides a system for producing sodium chloride brine suitable for use in a sodium hydroxide production plant having a chlor-alkali membrane cell, said system comprising:

a nanofiltration unit for nanofiltering feed water containing dissolved sodium chloride to produce a permeate and a retentate, wherein the retentate comprises at least 85% of any divalent ions from the feed water; and

a purification unit for receiving the permeate and producing the sodium chloride brine suitable for use in a sodium hydroxide production plant having a chlor-alkali membrane cell, wherein said purification unit comprises an electrodialysis unit for receiving the permeate and electrodialyzing the permeate to produce a concentrate having a greater concentration of total dissolved salts and a smaller proportion of divalent ions than the permeate and a diluent comprising water and divalent ions separated from the permeate.

In some embodiments, the purification unit further comprises a chemical precipitation treatment unit and/or an ion exchange treatment unit. In some other embodiments, the chemical precipitation treatment unit and/or the ion exchange treatment unit form part of the sodium hydroxide production plant in which the sodium chloride brine is used.

In some embodiments, the purification unit comprises a reverse osmosis unit for receiving a diluent from the electrodialysis unit and treating the diluent to produce a reverse osmosis retentate; wherein the reverse osmosis unit is fluidly connected to a nanofiltration unit so that at least part of the reverse osmosis retentate is supplied to that nanofiltration unit and feed water comprises the reverse osmosis retentate. The nanofiltration unit to which the reverse osmosis unit is fluidly connected may be the same nanofiltration unit that was used in the iteration of the process that produced that reverse osmosis retentate. Alternatively, the nanofiltration unit may be in another system that is arranged in series.

In addition, the present invention provides a process for producing sodium hydroxide, said process comprising:

a) nanofiltering feed water containing dissolved sodium chloride to produce a permeate and a retentate, wherein the retentate comprises at least 85% of any divalent ions from the feed water;

b) purifying the permeate to produce a sodium chloride brine having at least 180,000 ppm, for example at least 190,000 ppm, total dissolved salts and less than 250 ppm divalent ions, wherein step b) comprises electrodialyzing the permeate to produce a concentrate having a greater concentration of total dissolved salts and a smaller proportion of divalent ions than the permeate and a diluent comprising water and divalent ions separated from the permeate; and

c) electrolyzing said sodium chloride brine in a chlor-alkali membrane cell to produce sodium hydroxide.

In some embodiments, step b) further comprises:

treating the diluent using reverse osmosis to produce a reverse osmosis retentate; and

supplying at least part of the reverse osmosis retentate to step a). The concentrate produced in these embodiments may be the sodium chloride brine having at least 180,000 ppm, for example at least 190,000 ppm, total dissolved salts and less than 250 ppm divalent ions.

In some embodiments, step b) further comprises: treating the concentrate using chemical precipitation and/or ion exchange to produce the sodium chloride brine having at least 180,000 ppm, for example at least 190,000 ppm, total dissolved salts and less than 250 ppm divalent ions.

Furthermore, the present invention provides a system for producing sodium hydroxide, said system comprising:

a nanofiltration unit for nanofiltering feed water containing dissolved sodium chloride to produce a permeate and a retentate, wherein the retentate comprises at least 85% of any divalent ions from the feed water;

a purification unit for receiving the permeate and producing a sodium chloride brine having at least 180,000 ppm, for example at least 190,000 ppm, total dissolved salts and less than 250 ppm divalent ions, wherein said purification unit comprises an electrodialysis unit for receiving and electrodialyzing the permeate to produce a concentrate having a greater concentration of total dissolved salts and a smaller proportion of divalent ions than the permeate and a diluent comprising water and divalent ions separated from the permeate; and

a chlor-alkali membrane cell for receiving and electrolyzing said sodium chloride brine to produce sodium hydroxide.

The system is an integrated system that allows feed water to be converted into sodium hydroxide, without first evaporating the feed water to produce a crude salt. Thus, system may allow water resources to be used more efficiently than conventional sodium hydroxide production processes.

In some embodiments, the chlor-alkali membrane cell is fluidly connected to the purification unit, which may in turn be fluidly connected to the nanofiltration unit and the feed water source. By locating the chlor-alkali membrane cell so that it may be fluidly connected to the original source of the feed water (e.g., the sea), the system of the present invention avoids the costs and resources associated with producing sodium chloride brine or salt remotely and transporting the brine or salt by vehicle to the location of the sodium hydroxide plant.

In some embodiments, the purification unit comprises a reverse osmosis unit for receiving a diluent from the electrodialysis unit and treating the diluent to produce a reverse osmosis retentate; and the reverse osmosis unit is fluidly connected to a nanofiltration unit so that at least part of the reverse osmosis retentate is supplied to that nanofiltration unit and feed water comprises the reverse osmosis retentate. In these embodiments, electrodialyzing the permeate may produce a concentrate that is a sodium chloride brine having at least 180,000 ppm, for example at least 190,000 ppm, total dissolved salts and less than 250 ppm divalent ions. Alternatively or additionally, the purification unit may comprise a chemical precipitation unit for receiving the electrodialysis concentrate and performing chemical precipitation on the concentrate to produce sodium chloride brine having at least 180,000 ppm, for example at least 190,000 ppm, total dissolved salts and less than 250 ppm divalent ions. The system for producing sodium hydroxide may comprise an ion exchange treatment unit for receiving and treating the electrodialysis concentrate or the purified output of the chemical precipitation unit to produce sodium chloride brine having at least 180,000 ppm, for example at least 190,000 ppm, total dissolved salts and less than 250 ppm divalent ions.

Also, the present invention provides a process for the commercial production of soda ash, said process comprising:

a) preparing a sodium chloride brine by
nanofiltering feed water containing dissolved sodium chloride to produce a permeate and a retentate, wherein the retentate comprises at least 85% of any divalent ions from the feed water;
purifying the permeate to produce the sodium chloride brine having at least 180,000 ppm total dissolved salts and less than 250 ppm divalent ions, comprising electrodialyzing the permeate to produce a concentrate having a greater concentration of total dissolved salts and a smaller proportion of divalent ions than the permeate and a diluent comprising water and divalent ions separated from the permeate; and

b) using said sodium chloride brine in a soda ash production plant.

Brine that can be adopted for the commercial production of soda ash has a divalent ion content of about 250 ppm or less, and at least 180,000 ppm total dissolved salts, preferably at least 190,000 ppm total dissolved salts, more preferably at least 305,000 ppm total dissolved salts. In general, this brine can be used as sodium chloride precursor in all those known processes for the industrial synthesis of soda ash that employ sodium chloride in water solutions, for example, albeit not limited to, the Solvay process or processes derived from the Solvay process. In these processes, the sodium chloride brine would be mixed with a concentrated ammonia solution and the mixed solution put in contact with gaseous carbon dioxide to produce ammonium chloride and sodium bicarbonate. The carbon dioxide can be produced by calcination of limestone at 950-1100° C. The sodium bicarbonate is then separated and converted into soda ash by calcination at 160-230° C. Carbon dioxide and ammonia can be regenerated, respectively, during calcination of the sodium bicarbonate and by reacting the ammonium chloride solution with calcium oxide produced during calcination of the limestone.

As used herein, “feed water containing dissolved sodium chloride” includes water containing at least 1.5 wt. % dissolved sodium chloride. For convenience, feed water containing dissolved sodium chloride may also be referred to simply as “feed water”. The skilled person will readily understand that for the purpose of the invention the feed water can be any water solution from which it is desired to separate sodium chloride brine. In general, the present invention can be effectively used in all those processes that aim to separate monovalent ions from divalent ions in solutions containing sodium chloride. The monovalent ions can be concentrated in the electrodialysis concentrate, and the divalent ions in the nanofiltration reject.

The feed water can include any water source typically used for salt production including seawater, lake water, artesian water or groundwater, and brines produced from solution mining of rock salt deposits. Some embodiments of the present invention are particularly suited to the using seawater. Six ions make up over 99% by weight of all the dissolved solids in seawater. Sodium and chloride make up slightly more than 85% of all the dissolved solids in seawater, with seawater containing around 2.7 wt. % dissolved sodium chloride. Sodium accounts for about 30% and chloride accounts for slightly more than 55% by weight of all dissolved solids in seawater. The other four ions include calcium, magnesium, potassium and sulfate.

The feed water may be supplied to the process as raw water that has not undergone any form of pre-treatment or pre-treated water. Depending upon the source of the raw water, the water may be turbid and pre-treatment may be necessary to prevent suspended particles in the water from clogging or fouling the membranes used for nanofiltration. Accordingly, pre-treatment may include filtering the raw water using “coarser” forms of filtration than nanofiltration. Typical pre-treatment processes are media filtration (sand, anthracite, etc.) and cartridge filtration. Filtration may be preceded by coagulation and sedimentation, or flocculation and sedimentation, for highly turbid waters. In some embodiments, a combination of different types of filtration may be required to reduce the suspended material in the water to an acceptable level. For example, the raw water may undergo filtration, followed by microfiltration, and then ultrafiltration.

A commonly used predictor of the likelihood that feed water will cause fouling due to suspended particulates is the silt density index (SDI) of the feed water. The SDI is an empirical measurement, in accordance with ASTM Standard D-4189-07, of the time required to filter a fixed volume of water through a standard 0.45-micron pore size microfiltration membrane. Suspended material in the feed water that plugs the microfilter increases the sample filtration time, giving a higher SDI. For the purposes of the present invention, the feed water of the process will typically have an SDI of less than 2.5, preferably less than 1.5, even more preferably less than 1, and raw water may be pre-treated as necessary in order to achieve a suitable SDI.

As used herein, “feed water containing dissolved sodium chloride” also includes a stream supplied from a later stage of the inventive process. In some embodiments, the supplied stream is combined with a raw or pre-treated feed water stream. In other embodiments, the inventive process is operated so that all of the feed water is made up of the supplied stream. A supplied stream may be recycled or returned back into the system that produced that stream at first instance or it may be transferred to another system arranged in series.

In some embodiments, “feed water containing dissolved sodium chloride” is diluted seawater. Diluted seawater can be obtained by mixing seawater with water that has only traces of total dissolved salts. Water with traces of total dissolved salts can be, for example, potable water or condensate water. In some preferred embodiments, potable water or condensate water can be obtained from one or more streams of the system of the present invention. In these preferred embodiments, potable water may be obtained from the reverse osmosis permeate by known desalinization methods, for example brackish water reverse osmosis. Condensate water can be obtained from evaporation of, for example, the sodium chloride brine.

As mentioned above, “feed water containing dissolved sodium chloride” can also be natural brine taken from any available natural brine reserve, like the Salar de Atacama in South America, the Utah's Great Salt Lake in North America, or the Karinga Creek in Australia.

In general, depending on the feed water source, the sodium chloride brine that is separated may contain a variety of industrially relevant monovalent ions, such as sodium, lithium or potassium ions. These species can be extracted from the sodium chloride brine using methods that would be known to the skilled person. The nanofiltration reject would then contain most of the divalent ions, such as calcium or magnesium ions, which can be extracted accordingly.

In some embodiments of the invention, the feed water may also be a solution deriving from solution mining of rock salt deposits. In particular, the feed water may derive from the leaching of metal species, for example sodium, lithium, potassium, calcium or magnesium species, from mineral ore. If the leaching process is an acid leaching process, the feed water may be neutralized before the system is operated. The sodium chloride brine that is then collected would be rich in the monovalent ions of interest, while the divalent metal ions will be concentrated in the nanofiltration reject. The metal species can then be separated accordingly.

In the process of the present invention, the feed water is nanofiltered to produce a permeate and a retentate. By “nanofiltered”, “nanofiltering” or other variations thereof is meant filtering the feed water using one or more nanofiltration membranes. The permeate is the liquid that passes through the membrane(s), while the retentate is the liquid retained by the membrane(s).

By “nanofiltration unit” is meant a unit equipped with one or more nanofiltration membranes. The unit may comprise separate nanofiltration devices, each having one or more membranes, that are arrange in series, in parallel or combinations thereof. In some embodiments, the nanofiltration unit may include a pump to provide the feed water at a suitable pressure for nanofiltration. However, a pump for this purpose may be provided separate to the nanofiltration unit. Suitable pumps include high pressure pumps capable of delivering the feed water to the nanofiltration unit a pressures up to 3.0 MPa, although in some embodiments the pressure used for nanofiltration may be around 1.0 MPa to around 2.5 MPa.

Nanofiltration membranes fall in between the separation range of reverse osmosis and ultrafiltration membranes. Thus, these membranes are suited for the separation of particle sizes in the range of about 1 to about 10 nm and molecular weights of 200 g/mole and above. Nanofiltration membranes may be spiral wound, hollow fine fiber, tubular or plate configuration, although nearly a large number of commercial nanofiltration membranes are thin film composite types and are made of non-cellulosic polymers with a spiral wound configuration. The polymer is normally a hydrophobic type incorporating negatively charged groups. Nanofiltration membranes that have been found particularly useful in the present invention include the Seasoft Series membranes supplied by GE Water & Process Technologies, such as the Seasoft 8040 HF membrane or the Seasoft 8040 HR. Suitable membranes are also commercially available from Dow Chemicals, USA (for example the DOW FILMTEC NF270-400 membrane) and Hydranautics (for example, ESNA1-LF-4040 or ESNA1-LF membranes).

Unlike reverse osmosis and ultrafiltration membranes, nanofiltration membranes utilize two mechanisms to effect separation: rejection of neutral particles according to size and rejection of ionic matter by electrostatic interaction with a charged membrane. Additionally, nanofiltration membrane operation is also partially governed by osmotic principles. As a result, nanofiltration membranes achieve greater rejection of divalent ions (such as sulfate, calcium and magnesium ions) than univalent ions (such as dissolved sodium chloride). In the present invention, the nanofiltration retentate comprises at least 85% of any divalent ions from the feed water. In some embodiments, the retentate comprises at least 90% of any divalent ions from the feed water, preferably at least 95%. Certain membranes may retain more than 99% of the sulfate ions in the retentate.

Some univalent ions, including dissolved sodium chloride, may be retained in the nanofiltration retentate. In general, nanofiltration separates less than 40% of the dissolved sodium ions from the feed water into the retentate, preferably less than 35%, more preferably less than 20%.

In some embodiments, the composition of the ions in the retentate is equivalent to 90% or more of the calcium in the feed water, 95% or more of the magnesium from the feed water, 95% or more of the sulfate from the feed water, 87% or more of the bicarbonate from the feed water, and less than 35% of the sodium from the feed water.

In some embodiments, the retentate will constitute about 40% or less of the total feed water volume, preferably about 30% or less. That is, the permeate will constitute about 60% or more of the feed water volume, preferably about 70% or more of the feed water volume.

In some embodiments, to increase the amount of permeate recovered, the retentate from a first nanofiltration membrane (or device) will be subjected to nanofiltration in a second nanofiltration membrane (or device). Permeate from the first and second permeates are combined and purified to produce the sodium chloride brine. Accordingly, multiple nanofiltration membranes or devices can be arranged in series, with the permeate from each membrane or device combined with that of the other membranes or devices to maximize the amount of permeate recovered from nanofiltration of the feed water.

In some embodiments, to improve the purity of permeate recovered, the permeate from a first nanofiltration membrane (or device) will be subjected to nanofiltration in a second nanofiltration membrane (or device). These first and second nanofiltration stages may be operated at different pressures as the bulk of the divalent ions will pass into the retentate of the first nanofiltration membrane. Accordingly, it may be advantageous to adopt a higher operating pressure for the second nanofiltration membrane. In some embodiments, three or more membranes are arranged in series in order to successively treat the permeate. In some of these embodiments, the operating pressure for each membrane is successively increased along the series.

The nanofiltration retentate may have a total dissolved salt (TDS) content of approximately 72,000 ppm or less, preferably about 36,000 ppm. In some embodiments, the retentate can be discharged back to the source of the feed water. For example, if the feed water is (optionally pretreated) seawater, the retentate can be discharged back into the sea.

Alternatively, the retentate may be subjected to further processing in order to recover commercially valuable products from the impurities concentrated in the retentate. For example, the retentate can be processed to recover magnesium or calcium. This recovery may be performed using a chemical precipitation treatment similar to that employed to remove ions from raw brines produced using crude salt.

As noted above, the nanofiltration permeate is purified to produce a sodium chloride brine suitable for use in a sodium hydroxide production plant having a chlor-alkali membrane cell. In the present invention, purification includes electrodialyzing the permeate to produce a concentrate having a greater concentration of total dissolved salts and a smaller proportion of divalent ions than the permeate and a diluent comprising water and divalent ions separated from the permeate. In some embodiments, electrodialyzing may be more effective at separating water from the permeate than separating divalent ions from the permeate. Accordingly, the resulting concentrate may have a higher concentration of divalent ions in parts per million than the permeate, but this concentration of divalent ions will still represent a smaller proportion of the total dissolved salts of the concentrate than the concentration of divalent ions in the permeate represented relative to the total dissolved salts of the permeate.

As used herein, the term “electrodialyzing” and variations thereof mean the process of altering the composition and/or concentration of electrolyte solutions as a result of electromigration through membranes in contact with these solutions. Electrodialysis devices are commonly stacks of narrow compartments through which a feed solution is pumped. A voltage is applied across the stack by an anode at one end of the stack and a cathode at the other end. The compartments are separated by ion exchange membranes, which are commonly arranged in order as alternating cation-exchange and anion-exchange membranes which are selectively permeable to positive and negative ions, respectively. Electrodialysis devices suitable for the present invention may contain at least one pair of membranes comprising one anion-exchange membrane and one cation-exchange membrane. In some embodiments, the device may contain a plurality of pairs of such membranes, preferably 100 or more pairs, more preferably 300 or more pairs.

Suitable electrodialysis devices include those equipped to perform electrodialysis reversal. In electrodialysis reversal the electrical charge applied to the membranes is reversed periodically. By reversing the polarity, the chemical reaction at the electrodes reverses which can assist in controlling membrane scaling or fouling, thus allowing the device to operate continuously without maintenance for a longer period of time than systems that use conventional “unidirectional” electrodialysis. In some electrodialysis reversal devices, the polarity is switched two to four times an hour.

Electrodialysis separates the nanofiltration permeate into a concentrate and a diluent. As used herein, the term “concentrate” means the stream exiting the electrodialysis device or unit that has a higher concentration of dissolved salts than the nanofiltration permeate. The “diluent” is the stream exiting the electrodialysis device or unit that has been depleted in dissolved salt concentration relative to the nanofiltration permeate. When a device using electrodialysis reversal is used, the concentrate and diluent outputs will switch as the polarity is reversed. Such devices will typically be connected to other parts of inventive system with an appropriate system of valves to compensate for the outputs switching and ensure the continuous supply of the correct stream to the remainder of the process.

By “electrodialysis unit” is meant a unit equipped with one or more electrodialysis devices. Electrodialysis devices that are useful in the present invention include those produced by Astom Corporation, such as the Acilyzer 25-300 model, or those produced by Tokuyama Corporation, such as the TSW-200 model. The TSW-200 model has 3200 membrane pairs with each pair having an effective area of 2 m² and a 0.75 mm separation between adjacent membranes. The Acilyzer 25-300 model has 300 membrane pairs and a total effective membrane surface area of 75 m² for each half of the cell pairs, and is particularly suited to use in the present invention. Suitable devices that can perform electrodialysis reversal include the Acylizer EDR of Astom Corporation.

In a preferred embodiment, the electrodialysis device comprises at least one membrane that is a univalent anion-selective membrane and at least one other membrane that is a univalent cation-selective membrane. Univalent anion-selective membranes are anion-exchange membranes that selectively pass univalent anions, such as chlorine anions, while selectively rejecting divalent anions, such as sulfate ions. Examples of univalent anion-selective membranes that are useful in the present invention include selective membranes marketed by Astom Corporation under the trade name NEOSEPTA and being of the grade ACS. Univalent cation-selective membranes are cation-exchange membranes that selectively pass univalent cations, such as sodium ions, while selectively rejecting divalent cations, such as calcium and magnesium ions. Examples of univalent cation-selective membranes that are useful in the present invention include selective membranes marketed by Astom Corporation under the trade name NEOSEPTA and being of grade CIMS.

In some embodiments, each of the cation-exchange and anion-exchange membranes is a univalent ion selective membrane. For example, the electrodialysis device may comprise a stack composed of alternating NEOSEPTA ACS and NEOSEPTA CIMS membranes.

The nanofiltration permeate is separated via electrodialysis into a concentrate and a diluent. The volume of concentrate may be equivalent to about 2 to about 4% of the total volume of nanofiltration permeate, preferably about 2.5 to about 3%. When univalent ion-selective membranes are used, the electrodialysis concentrate may contain high levels of sodium chloride, such as, for example, above 200,000 ppm. It is preferred that the concentrate contains sodium chloride at a concentration above 210,000 ppm, more preferably above 220,000 ppm, and even more preferably above 240,000 ppm. In some embodiments, such as when the feed water comprises reverse osmosis retentate, the electrodialysis concentrate may have a sodium chloride concentration of 300,000 ppm or higher.

In some embodiments, to increase the amount of concentrate recovered, the diluent from a first electrodialysis device will be subjected to electrodialysis in a second electrodialysis device. The first and second concentrates are combined and may be purified to produce the sodium chloride brine. Accordingly, multiple electrodialysis devices can be arranged in series, with the concentrate from each device combined with that of the other devices to maximize the amount of concentrate recovered.

In some embodiments, to improve the purity of concentrate recovered, the concentrate from a first electrodialysis device will be subjected to electrodialysis in a second electrodialysis device. In some embodiments, three or more devices are arranged in series in order to successively treat the concentrate.

The electrodialysis concentrate will typically have less than 700 ppm divalent ions. In some embodiments, the electrodialysis concentrate has less than 350 ppm divalent ions, preferably less than 100 ppm. For example, the nanofiltration permeate may have a calcium content of 8 ppm and a magnesium content of 13.5 ppm, which will result is an electrodialysis concentrate having about 32 ppm calcium and about 21 ppm magnesium, with the total amount of divalent ions being less than 100 ppm.

In some embodiments, the electrodialysis concentrate may be subjected to nanofiltration in order to further reduce the total level of impurities. This may be achieved by recycling the electrodialysis concentrate back to the initial nanofiltration stage. In some embodiments, the process of the present invention is operated batch-wise. In these embodiments, a batch of feed water may be processed and all the resulting the electrodialysis concentrate may be recycled back to the nanofiltration stage, without being combined with a new batch of feed water.

Alternatively, at least a portion of the electrodialysis concentrate may be combined with the feed water entering the nanofiltration unit. This may occur when the process is operated continuously.

In some other embodiments, there is a separate second nanofiltration unit located downstream from the first nanofiltration unit and the electrodialysis unit. In these embodiments, the permeate of the second nanofiltration unit may be sodium chloride brine suitable for use in a chlor-alkali membrane cell. Alternatively, the permeate of the second nanofiltration unit may be fed to a second electrodialysis unit and the electrodialysis concentrate may be sodium chloride brine suitable for use in a chlor-alkali membrane cell. In some embodiments, three of more stages of nanofiltration and electrodialysis may be arranged in series in order to achieve sodium chloride brine of suitable purity.

The electrodialysis diluent may be treated using reverse osmosis to produce a reverse osmosis retentate. This reverse osmosis retentate may then be supplied to a nanofiltration unit so that the feed water comprises the reverse osmosis retentate. The electrodialysis concentrate produced using feed water comprising the reverse osmosis retentate may have lower levels of divalent ions and higher levels of total dissolved salts than the concentrate produced using raw feed water. This is a consequence of the initial nanofiltration stage in which 85% of divalent ions are removed. The electrodialysis diluent fed to the reverse osmosis stage accordingly has a lower proportion of divalent ions relative to total salts compared to the initial feed water. Thus, the retentate produced by the reverse osmosis treatment may have a higher level of total salts compared to the initial feed water, with the majority being dissolved sodium chloride, and a relatively small proportion of divalent ions. By subjecting this retentate to nanofiltration and electrodialysis the proportion of divalent ions is further reduced and the resulting electrodialysis concentrate may have more than 300,000 ppm total dissolved salts and less than 250 ppm divalent ions. In embodiments where the feed water is predominantly or entirely made up of the reverse osmosis retentate the concentration of divalent ions in the electrodialysis concentrate may be as low as 20 ppb.

By “treating the diluent using reverse osmosis” or other variations thereof is meant treating the diluent using one or more reverse osmosis membranes. The reverse osmosis permeate is the liquid that passes through the membrane(s), while the retentate is the liquid retained by the membrane(s). Reverse osmosis is so called because “osmosis” is defined as the passage of a liquid from a dilute to a more concentrated solution through the membrane, whereas “reverse osmosis” uses the same principle but, by applying pressure to the concentrated solution, forces flow of the permeate liquid in the reverse direction. In the process of the present invention, the pressure applied to the diluent during reverse osmosis treatment is in the order to 6 to 7 MPa.

In comparison to nanofiltration membranes, reverse osmosis membranes have a greater degree of impermeability to ions and organic compounds. Reverse osmosis membranes are relatively impermeable to virtually all ions, including sodium chloride. Therefore, reverse osmosis membranes are widely used for the desalination of saline or brackish water to produce potable water. The reverse osmosis membranes used in the present invention may be spiral wound polyamide membranes. Suitable membranes for the present invention include those commercially available from Dow Chemicals, USA (for example the DOW FILMTEC reverse osmosis membranes) and Hydranautics. Reverse osmosis membranes that have been found particularly useful in the present invention include FILMTEC reverse osmosis membranes specifically designed for processing seawater, such as the SW30HR-380 membrane, or processing brackish water, such as the BW30-4040 membrane.

By “reverse osmosis unit” is meant a unit equipped with one or more reverse osmosis membranes. The unit may comprise separate reverse osmosis devices, each having one or more membranes, that are arrange in series, in parallel or combinations thereof. Reverse osmosis devices that are useful in the present invention include seawater reverse osmosis units, for example units equipped with FILMTEC SW30HR-380 membranes, and brackish water reverse osmosis units, for example units equipped with FILMTEC BW30-4040 membranes.

Certain chlor-alkali membrane cells can operate with divalent impurity levels of about 250 ppm or less. However, as impurity levels increase the membrane life of the cell is reduced. Thus, the costs of replacing chlor-alkali membranes must be balanced with the costs of obtaining brines of a high purity. For some chlor-alkali membrane cells the impurities in the brine must be less than 200 ppm. In these embodiments, the electrodialysis concentrate may be further purified by subjecting the concentrate to chemical precipitation treatment to produce the sodium chloride brine. The chemical precipitation process to remove divalent ions such as calcium, magnesium and sulfate will be in accordance with conventional methods already used to purify brines for chlor-alkali membrane cells. For example, sulfate may be precipitated by adding calcium chloride, calcium in the electrodialysis concentrate and also residual calcium chloride may be removed in a secondary process step through precipitation following the addition of sodium carbonate, and magnesium may precipitated through the addition of sodium hydroxide. The precipitation reagents will be overdosed in accordance with usual practice. However, as there is typically less than 700 ppm divalent ions in the electrodialysis concentrate, it will be appreciated that the total amount of each reagent will be significantly reduced compared to the amount required for purifying raw brines produced from crude salt.

Once the impurities are precipitated, the treated concentrate will be filtered. For example, the precipitated impurities may be removed using a centrifuge. The centrifuge may be operated continuously to remove the precipitates. In some embodiments, a flocculent may be added to facilitate filtration of the precipitates out of the treated concentrate. Continuous precipitate removal using a centrifuge is advantageous compared to the plate and frame filter presses utilized in conventional solar salt produce processes which are operated batch-wise.

The treated and filtered electrodialysis concentrate (i.e., resulting sodium chloride brine) may have less than 1 ppm divalent ions, preferably less than 50 ppb.

For some chlor-alkali membrane cells it is desirable for the sodium chloride brine to have 20 ppb divalent ions or less. To achieve such low levels of impurities, it may be necessary to perform an ion exchange treatment in addition to chemical precipitation. The ion exchange treatment may be performed in accordance with conventional methods of brine purification. Thus, the filtered electrodialysis concentrate may be further purified using ion exchange resin systems having chelating resins to produce sodium chloride brine having 20 ppb divalent ions or less. Suitable resins include macroporous, aminoalkylphosphonic or iminodiacetic acid chelating resins for removing divalent cations (e.g., calcium, magnesium) from brines. Examples of such resin are described in U.S. Pat. No. 5,804,606, the entire contents of which is incorporated herein by reference.

For some chlor-alkali membrane cells, it is desirable for the sodium chloride brine to be saturated, i.e., about 300,000 to about 315,000 ppm total dissolved salts, subject to operating temperature, where the vast majority of the dissolved salts content is made up of dissolved sodium chloride. Accordingly, in some embodiments, the process may include evaporating the concentrate (optionally after performing chemical precipitation treatment and/or ion exchange treatment) to produce a saturated sodium chloride brine. Evaporation may be conducted at atmospheric pressure or under vacuum. Evaporation may be conducted using single or multiple-effect evaporators, including thermal or mechanical vapor recompression evaporators, or flash evaporators. For example, mechanical vapor recompression systems, such as those supplied by Veolia Water Solutions & Technologies, may be used to produce the saturated sodium chloride brine.

In some embodiments, it may be desirable to limit the concentration of the electrodialysis concentrate to 240,000 ppm total dissolved salts; otherwise salts may begin to crystallize on the membranes. In these embodiments, subsequently evaporating the concentrate can be advantageous as brines with higher concentrations, such as saturated brines, are desirable for use in a chlor-alkali membrane cell.

The sodium chloride brine produced in accordance with the present invention may be evaporated, crystallized, and dried to produce sodium chloride crystals of 99.99% purity. For example, the brine may be evaporated under vacuum and crystallized into 99.99% pure sodium chloride. The sodium chloride crystals may then be dried by centrifuging. These centrifuged crystals may be further dried in a fluidized bed drier before being packed as a final product.

As a result of the purity of the sodium chloride brine, the crystallization process should not result in significant production of bitterns. Furthermore, it may not be necessary to wash the crystallized salt. Accordingly, crystallizing the sodium chloride brine of the present invention may minimize salt losses that are associated with producing salt through solar evaporation. It will also be appreciated that, in terms of land usage, the system of the present invention has a significantly smaller footprint than the ponds required to produce salt through solar evaporation.

In some embodiments of the invention, the condensate resulting from the evaporation process can be recovered and, for example, treated to produce potable water, used for regenerating the ion exchange resin (if ion exchange treatment is used) or used in the feed water.

The sodium chloride brine produced in accordance with the present invention is suitable for use in a chlor-alkali membrane cell. Accordingly, the sodium chloride brine may be directly fed into the membrane cell and electrolyzed to produce sodium hydroxide. Thus, the present invention may provide an integrated system for producing sodium hydroxide from feed water.

In some embodiments, an existing sodium hydroxide plant located near a source of feed water, for example coastal plants located near seawater, may be modified to introduce nanofiltration and electrodialysis units in order to perform the process of the present invention. These embodiments may use, together with the chlor-alkali membrane cell(s), existing purification equipment to supply a sodium chloride brine of suitable purity to the cell. For example, existing chemical precipitation and ion exchange facilities may be modified to process the electrodialysis concentrate.

In some embodiments, the nanofiltration and electrodialysis units may be located remotely to the plant having the chlor-alkali membrane cell. However, in these embodiments, the nanofiltration and electrodialysis units may nevertheless be fluidly connected to the chlor-alkali membrane cell so that the brine may be pumped to the sodium hydroxide plant. Additional purification facilities, such as chemical precipitation and ion exchange facilities, may be located together with the nanofiltration and electrodialysis units or may form part of the sodium hydroxide plant.

In embodiments of the system comprising a reverse osmosis unit, the reverse osmosis unit is typically located together with the nanofiltration and electrodialysis units.

After sodium hydroxide has been produced, the depleted brine may be recycled. The depleted brine may have a sodium chloride concentration of about 280,000 ppm and can be recycled back to the purification unit after it has been de-chlorinated. For example, the depleted brine may be combined with the electrodialysis concentrate before the concentrate is evaporated to produce saturated sodium chloride brine that is then fed to the chlor-alkali membrane cell. The depleted brine may be combined with the electrodialysis concentrate after it has been subjected to chemical precipitation and/or ion exchange.

As discussed above, the nanofiltration permeate is separated via electrodialysis into a concentrate and a diluent. The volume of concentrate may be equivalent to about 2 to about 4% of the total volume of nanofiltration permeate. The remaining 96 to 98% represented by the diluent may have a TDS level of about 18,000 ppm. The electrodialysis diluent may be treated using a known desalination methods, such as reverse osmosis, to produce potable water having TDS of, for example, less than 500 ppm. Water having a TDS level of less than 600 mg/liter is generally considered to have good water palatability in accordance with the World Health Organization Guidelines for Drinking-Water Quality, third edition, 2008.

In some embodiments, the electrodialysis diluent is treated using reverse osmosis to recover about 75% of its volume as potable water having less than 500 ppm TDS.

The process of the present invention can also be operated by feeding the electrodialysis diluent into a reverse osmosis unit, and recycling the retentate of the reverse osmosis unit into the feed water. In this configuration, the system can either be operated in a batch-wise manner or as a continuous system working in a steady state. In such a system, the concentration of total dissolved salts in the recycled reverse osmosis retentate can influence the composition of the sodium chloride brine. In particular, an increase in the concentration of total dissolved salts in the reverse osmosis retentate would provoke an increase of the sodium concentration in the sodium chloride brine and, in turn, a decrease of its divalent ions content.

The concentration of total dissolved salts in the recycled reverse osmosis retentate will also determine the osmotic pressure of the retentate stream. Once the reverse osmosis retentate is recycled into the feed water, their combined pressure should remain within the operational limits of the nanofiltration unit feeding pump. Also, the concentration of total dissolved salts in the combined stream should not exceed the saturation limit of any of the dissolved salts, to prevent crystallization of salts in the nanofiltration membranes. These issues can be avoided by selecting and maintain an appropriate level of total dissolved salts in the recycled reverse osmosis retentate.

When seawater is used as feed water in the recycle system, the total dissolved salts in the recycled reverse osmosis retentate are maintained at a concentration that is equal to or less than about 6% (60,000 ppm), preferably about 6%. In these embodiments, the combined stream of feed water and reverse osmosis retentate, which feeds the nanofiltration unit, has a concentration of total dissolved salts of less than or equal to about 4% (40,000 ppm), preferably about 4%. In a further preferred embodiment, the concentration of total dissolved salts in the reverse osmosis retentate and in the nanofiltration feed is, respectively, about 6% and about 4%.

When diluted seawater is used as feed water in the recycle system, the level of total dissolved salts of the nanofiltration unit feed stream is maintained at a value that is less than or equal to about 4% (40,000 ppm), preferably about 4%, by recycling a reverse osmosis retentate with total dissolved salts of less than or equal to 9.5% (95,000 ppm), preferably between about 9% (90,000 ppm) and 9.5%, more preferably about 9.5%. Compared to embodiments that do not contemplate the use of diluted seawater, these embodiments are particularly advantageous when it is desired to further decrease the concentration of divalent ions (i.e., calcium, magnesium, sulphate and the like ions) in the nanofiltration feed.

A skilled person would understand that the production of sodium chloride brine according to the present invention can also be achieved in an automated and remotely controlled manner. This can be performed adopting discrete, batch or continuous control systems known in the art according to the modality in which the process of the present invention is operated. The control systems would comprise a hardware network of sensors and actuators installed in the relevant sections of the system of the present invention. The sensors and the actuators hardware network would be wired into a main control unit, i.e., a programmable logic control (PLC) unit. The control unit can be configured through suitable process control software, i.e., statistical or multivariable control software, installed in a computer processor. The system would be designed to operate according to process parameter values that would be pre-set by an operator. The software will automatically compare the pre-set process parameter values with the corresponding values recorded by the network of sensors. If the recorded values differ from the pre-set values, the software will send inputs to the control unit to automatically adjust the relevant process parameters to the pre-set values by operating suitable actuators that would be installed in the relevant sections of the system. The software will operate the actuators on the basis of the input data of the sensors, and will adjust the system to match the pre-set values by commonly known feedback control algorithms, i.e., proportional, integral, derivative, or any combinations of proportional, integral and derivative.

Sensors can be contact or non-contact temperature sensors (i.e., thermometers, resistance temperature detectors, thermocouples, infra-red detectors, pyrometers, etc.), pressure sensors (i.e., elastic sensors, electric sensors, differential pressure cells, vacuum sensors, etc.), flow and flow volume sensors (i.e., differential pressure meters, direct force meters, frequency meters, ultrasonic meters, magnetic meters, calorimetric meters, gear meters, thermal meters etc.), composition sensors (i.e., photometric sensors, electrometric sensors, etc.), pH sensors, and sensors of the like that are known in the art.

Actuators could be, for example, valves that can vary the flux of the system streams (i.e., pneumatic valves, hydraulic valves, electric valves, etc.), adjustable speed drives for the pumps (i.e., mechanical, hydraulic, electric adjustable speed drives, etc.), and actuators of the like that are known in the art.

For example, the concentration of total dissolved salts in the reverse osmosis retentate can be maintained at a constant pre-set value by such an automatic feedback control. A pre-set concentration can be the input of the process control software. The software can then operate a flux control valve placed in the reverse osmosis feed stream, so that the concentration of salts in the retentate stream, measured by a composition sensor such as an electrometric sensor, can match the initial pre-set value.

Further, considering that the operative pressure of the nanofiltration unit feed depends on the concentration and the osmotic pressure of the reverse osmosis retentate, a variable speed drive can be used to control the frequency and the power consumption of the feed pump. The control software will automatically operate the variable speed drive on the basis of the pressure data received by a pressure sensor placed in the nanofiltration unit feed. Similarly, the nanofiltration retentate can also be routed through a pressure exchanger or similar device in order to reduce power consumption.

### BRIEF DESCRIPTION OF THE SEVERAL VIEWS OF THE DRAWINGS

Various embodiments of the present invention are described in further detail below, by way of example, with reference to the accompanying drawings, in which:

FIG. 1 is a process flow diagram of one embodiment of the invention;

FIG. 2 is a process flow diagram of an embodiment of the nanofiltration unit that may be used in the system of the present invention;

FIG. 3 is a process flow diagram of an embodiment of the electrodialysis unit that may be used in the system of the present invention;

FIG. 4 is a process flow diagram of embodiment of the purification unit that may be used in the system of the present invention;

FIG. 5 is a process flow diagram of the embodiment of Example 1; and

FIG. 6 is a process flow diagram of the embodiment of Example 2.

### DETAILED DESCRIPTION

Illustrated embodiments of the present invention are described below by way of example only.

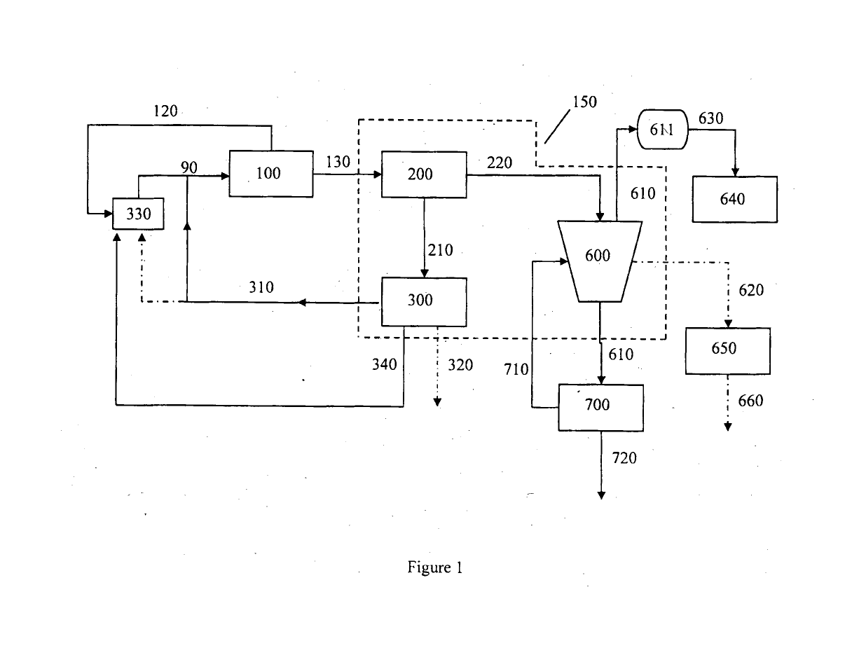

FIG. 1 shows process flow diagram of one embodiment of the invention. The feed water stream 90 of this embodiment is seawater. Thus, the feed water source 330 is the sea.

In this embodiment, processes for producing saturated sodium chloride brine 610, 99.99% pure sodium chloride crystals 620 and potable water 320 are illustrated.

In this embodiment, the feed water stream 90 is fed into nanofiltration unit 100 to produce a permeate 130 and a retentate 120. The nanofiltration unit 100 may include one or more nanofiltration devices (not shown in FIG. 1) having membranes such as the Seasoft Series membranes supplied by GE Water& Process Technologies. In this embodiment, the feed water stream 90 is fed into nanofiltration unit 100 at a pressure less than 1.2 MPa, preferably at 1.0 MPa. At these pressures, at least 85% of the divalent ions in the feed water stream 90 are separated into the retentate 120. The retentate is then discharged into the feed water source 330 (the sea).

The permeate 130 having, for example, 23,000 ppm TDS is fed into the purification unit 150. The purification unit includes an electrodialysis unit 200, which may include one or more electrodialysis devices (not shown in FIG. 1) such as the Acilyzer 25-300 electrodialyzer supplied by Astom Corporation. The permeate 130 is fed continuously at a rate of about 1675 m³/hr and at a pressure of 0.2 MPa at 35° C. into electrodialysis unit 200. In embodiments where the electrodialysis unit 200 includes an Acilyzer 25-300 electrodialyzer, the electrodialyzer is operated with a 380V, 60 Hz, 3 phase at 60 Amps, power supply.

The concentrate 220 from electrodialysis unit 200 is discharged at the rate of 39 m³/hr and has about 230,000 ppm TDS. The divalent ion content in the concentrate 220 is less than about 700 ppm. The sodium chloride content of the concentrate 220 is over 210,000 ppm.

The diluent 210 from electrodialysis unit 200 has a TDS level of about 18,000 ppm and is fed to a reverse osmosis unit 300 in order to recover potable water 320. The retentate 310 of the reverse osmosis unit 300 may have about 60,000 ppm TDS. That is, the retentate 310 may have a TDS content that is nearly twice that of seawater and, accordingly, can be recycled into the feed water stream 90, as shown in FIG. 1. Alternatively, as indicated by the broken line in FIG. 1, it may be discharged into the feed water source 330.

When the retentate 310 is recycled to the feed water stream 90, the reverse osmosis unit 300 forms part of the purification unit 150. As noted above, the retentate 310 may be about 60,000 ppm TDS. Of these dissolved salts, about 700 ppm are divalent ions. Accordingly, when this retentate 310 is recycled to the feed stream 90 and processed using the nanofiltration unit 100 and the electrodialysis unit 200, the resulting concentrate 220 has about 305,000 ppm TDS and less than 250 ppm divalent ions.

In embodiments where the retentate 310 is recycled the reverse osmosis unit 300 may produce a permeate 340 having about 8,600 ppm TDS, which can be discharged into the feed water source 330 or fed to a further brackish water reverse osmosis unit (not shown) in order to recover potable water. Alternatively, as indicated by the broken line in FIG. 1, in embodiments where the retentate 310 is not recycled, more than 75% of the volume of the diluent 210 may be recovered as potable water 320 with less than 500 ppm TDS.

In the embodiment illustrated in FIG. 1, the concentrate 220 from electrodialysis unit 200 is fed into a single-effect mechanical vapor recompression unit (MVR) 600. Vapor 610 from the concentrate 220 is condensed in a condenser 611 and the resulting condensate 630 is stored in a receiver 640. The vapor condensate 630 may have less than 10 ppm TDS. In some embodiments, the vapor condensate 630 can be combined with the potable water 320 (not illustrated in FIG. 1).

In accordance with a first process flow path, the concentrate 220 from electrodialysis unit 200 is evaporated using the MVR 600 until it becomes a saturated brine 610 having a concentration of 315,000 ppm. The saturated brine 610 can be stored separately and later shipped to a remote sodium hydroxide plant. Alternatively, as shown in FIG. 1, it can be directly fed into a chlor-alkali unit 700 comprising at least one membrane cell for producing sodium hydroxide 720. The depleted brine 710, which may have a sodium chloride concentration of about 280,000 ppm, can be returned back to MVR 600, after the depleted brine has been de-chlorinated, for evaporation. The depleted brine 710 may be evaporated along with the concentrate 220 to produce the saturated brine 610.

In accordance with a second process flow path (shown in broken lines), the concentrate 220 from electrodialysis unit 200 is evaporated using the MVR 600 until sodium chloride crystals 620 are produced. These crystals 620 are processed in a drying unit 650, which may include a centrifuge and a fluidized drying bed, to produce dried bulk sodium chloride 660.

In general, only one of the first and second flow paths will be adopted in implementing the invention. However, in some embodiments, plural MVRs 600 may be used to enable the first and second flow paths to be implemented concurrently.

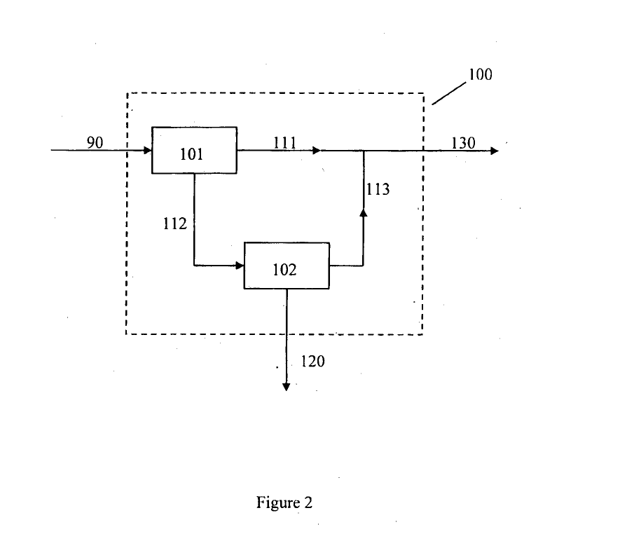

FIG. 2 illustrates an embodiment of the nanofiltration unit 100 comprising two nanofiltration devices 101, 102. The retentate 112 from the first nanofiltration device 101 is fed to the second nanofiltration device 102 at a slightly elevated pressure compared to the pressure used for the first nanofiltration device 101. The total recovery volume from both nanofiltration devices 101, 102 will be around 70% of the input volume. The permeates 111, 113 from the nanofiltration devices 101, 102 are combined to form permeate 130, which will have about 23,000 ppm TDS. The retentate 120 of the nanofiltration unit 100 is emitted from the second nanofiltration device 102 has about 72,000 ppm TDS.

The dissolved salts in the retentate 112 represent the bulk (i.e., at least 85%) of the divalent ions such as calcium, magnesium and sulfate ions, and include only a minor portion of univalent ions, such as sodium, potassium and chloride ions, from the feed water stream 90. In the second nanofiltration device 102, a relatively smaller proportion of univalent ions are separated into the retentate 120, thus increasing the ratio of divalent ions to univalent ions in the retentate 120. The ions in the permeate 113 from the second nanofiltration device 102 will substantially be univalent ions.

The retentate 120, which is rich in divalent ions, can be further treated to recover calcium and magnesium. Alternatively, it may be discharged into the feed water source 330.

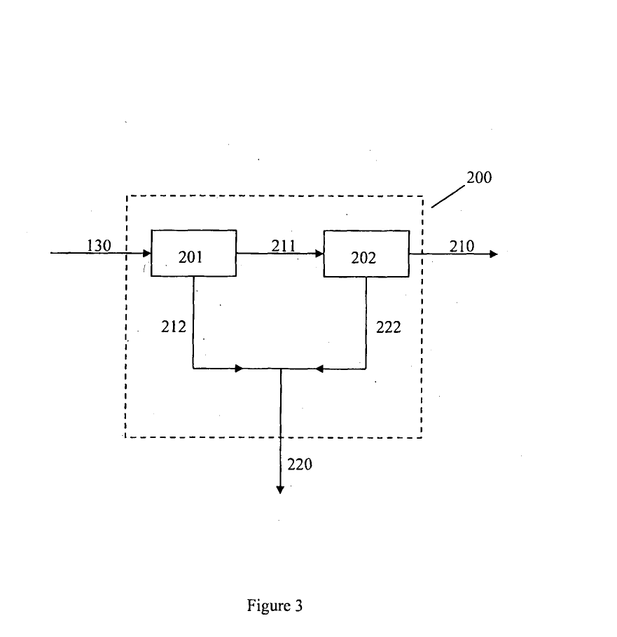

FIG. 3 illustrates an embodiment of the electrodialysis unit 200 comprising two electrodialysis devices 201, 202. The diluent 211 from the first electrodialysis device 201 has about 18,000 ppm TDS and is fed into the second electrodialysis device 202, which produces concentrate 222 and diluent 210. The concentrate 222 is mixed with the concentrate 212 of the first device 201 to form concentrate 220. The concentrate 220 may be further processed in other parts of the purification unit 150, such as in a MVR 600 as shown in FIG. 1. The diluent 210 of this embodiment will have a low level of TDS and can be discharged back into the feed water source 330.

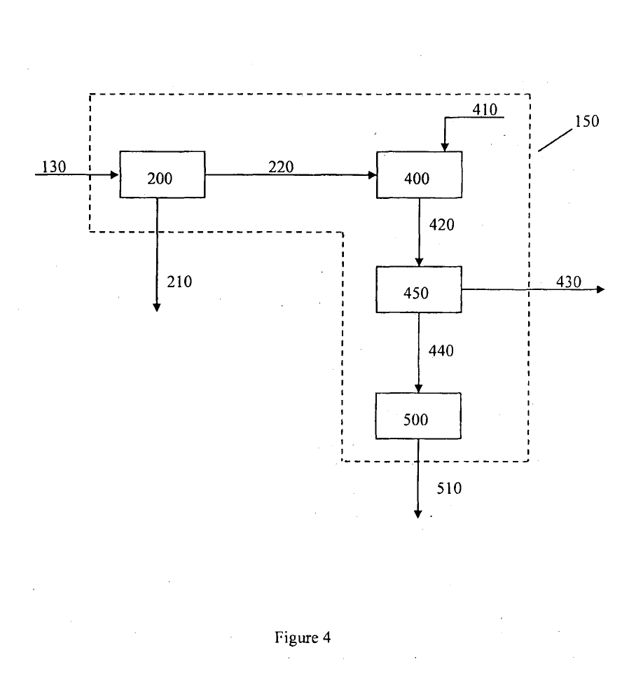

An alternative embodiment of the purification unit is illustrated in FIG. 4. In this embodiment, the concentrate 220 from the electrodialysis unit 200 is treated in a chemical precipitation unit 400.

The concentrate 220 is dosed with reagents 410 in the unit 400. The reagents 410 include: a solution of calcium chloride 410a, a solution of sodium hydroxide 410b and a solution of sodium carbonate 410c. The calcium chloride solution 410a is added in a sufficient quantity to remove sulfate ions from the concentrate 220 as calcium sulfate 420a. Likewise, the sodium hydroxide solution 410b is added in a sufficient quantity to ensure that magnesium in the concentrate 220 is precipitated as magnesium hydroxide 420b. Sufficient sodium carbonate is added to precipitate calcium from the concentrate 220 as well as any residual calcium from the calcium chloride solution 410a. The calcium is precipitated as calcium carbonate 420c. A slurry 420 including the precipitated calcium sulfate 420a, magnesium hydroxide 420b and calcium carbonate 420c is filtered in filtration unit 450 to produce a filtered brine stream 440 and solid residue 430 comprising the precipitated calcium sulfate 420a, magnesium hydroxide 420b and calcium carbonate 420c.

In this embodiment of the present invention, the chemical precipitation is performed in accordance with the methods of chemical precipitation utilized to purify raw brines made of crude salt in preparation for the synthesis of sodium hydroxide. However, since the impurity level in the concentrate 220 is only about 700 ppm, only a minor amount of the reagents 410 are required compared to conventional processes. In addition, the quantity of solid residue 430 produced will also be minor compared to conventional processes in which raw brine is purified. The filtered brine stream 440 is further treated in an ion exchange unit 500 to reduce the total impurities in the brine and produce a purified brine 510 having less than 20 ppb impurities, including divalent ions. The ion exchange unit 500 includes an ion exchange resin bed that utilizes a chelating ion exchange resin. The relative affinity of the resins for various cations may decrease in the following order: Mg>Ca>Sr>Ba>Na>K.

The filtered brine stream 440 may have a sodium chloride concentration of about 300,000 ppm and a pH of about 11. This stream 440 will be fed into the ion exchange unit at a temperature of about 60° C. The flow rate through the ion exchange unit 500 may be based upon the volume of the ion exchange resin bed, and flow rates of about 20 bed volumes per hour are considered to be useful for the present invention. Particularly suitable resins, such as those described in U.S. Pat. No. 5,804,606, can be used under these conditions for about 72 hours before the resins require regeneration.

In some embodiments, the purified brine 510 may be directly fed into a chlor-alkali unit 700 comprising at least one membrane cell for producing sodium hydroxide 720. In some other embodiments, the purified brine may be fed into a MVR 600 and proceed along the first or second process flow paths illustrated in FIG. 1 in order to produce sodium hydroxide 720 or dried bulk sodium chloride 660.

The present invention is further illustrated by the following non-limiting examples.

### EXAMPLES

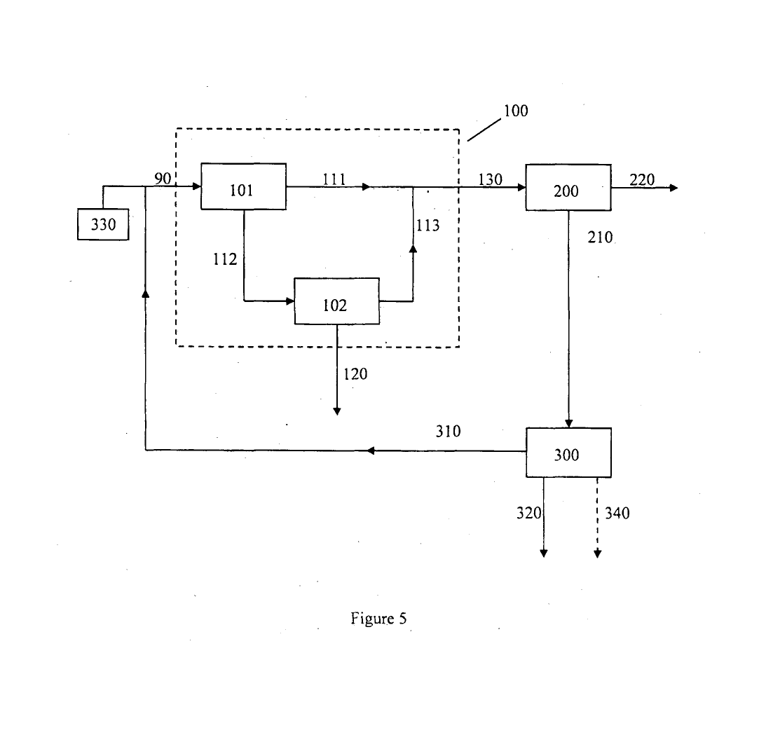

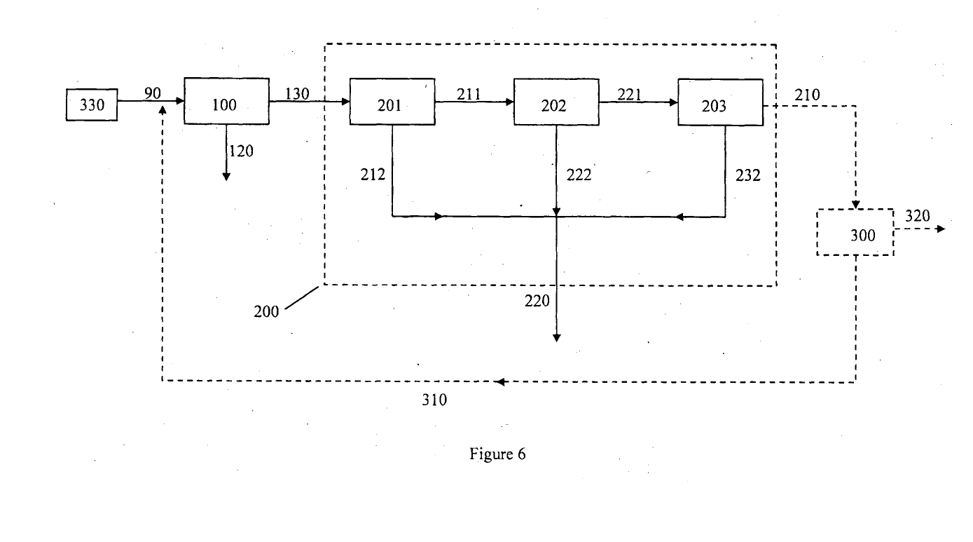

The Examples described below and illustrated by FIGS. 5 and 6 are of embodiments of the process in accordance with the present invention. The performance of these embodiments and the resulting compositions of various process streams have been calculated based upon the operating parameters described in further detail below.

### Example 1

FIG. 5 illustrates the process flow diagram for Example 1.

The feed water for this Example is initially seawater having the composition shown in Table 1 and an SDI of less than 1.5. The feed water source 330 in this Example is the sea.

TABLE 1
Seawater Composition
Ion content (ppm)

| | |
|---|---|
| Na | 10,500.00 |
| Ca | 432.00 |
| Mg | 1,244.00 |
| K | 240.00 |
| Total Cations | 12,416.00 |
| HCO₃ | 100.00 |
| SO₄ | 2,263.00 |
| Cl | 19,072.80 |
| Total Anions | 21,435.80 |
| TDS | 33,851.80 |

At the start of the process, seawater is fed as feed water stream 90 at a rate of 8.49 m³/hr into a nanofiltration unit 100. The nanofiltration unit 100 is equipped with two nanofiltration devices 101, 102. Each nanofiltration device 101,102 includes Seasoft 8040 HR thin film, spiral wound membranes supplied by GE Water & Process Technologies. The membranes are operated with a flux of 20 l/m²/hr and each have an active surface area of 36 m². The first nanofiltration device 101 has three membrane arrays, while the second nanofiltration device 102 has four membrane arrays. The feed water stream is fed to the first nanofiltration device via a pump 141 (not shown) at a pressure of 1.79 MPa. The retentate 112 from the first nanofiltration device 101 is fed to the second nanofiltration device 102 at a slightly elevated pressure of 2.5 MPa via a pump 142 (not shown) at a rate of 3.72 m³/hr. The permeates 111, 113 from the nanofiltration devices 101, 102 are combined to form permeate 130. The permeate 111 is calculated to be emitted at a rate of 4.77 m³/hr, and the permeate 113 is calculated to be emitted at a rate of 2.03 m³/hr. Thus, the total recovery rate from both nanofiltration devices 101, 102 is calculated to be 6.8 m³/hr, which equates to around 80% of the feed water stream 90 input. The calculated composition of the permeate 130 from the nanofiltration unit 100 is shown in Table 2.

TABLE 2
Nanofiltration Permeate 130 Composition
Ion content (ppm)

| | |
|---|---|
| Na | 9,207.00 |
| Ca | 88.83 |
| Mg | 135.37 |
| K | 210.00 |
| Total Cations | 9,641.20 |
| HCO₃ | 85.85 |
| SO₄ | 0.00 |
| Cl | 14,911.00 |
| Total Anions | 14,996.85 |
| TDS | 24,638.05 |

The retentate 120 of the nanofiltration unit 100 is calculated to be emitted from the second nanofiltration device 102 at a rate of 1.69 m³/hr, and its calculated composition is shown below in Table 3.

TABLE 3
Nanofiltration Retentate 120 Composition
Ion content (ppm)

| | |
|---|---|
| Na | 15,702.95 |
| Ca | 1,814.79 |
| Mg | 5,705.32 |
| K | 360.35 |
| Total Cations | 23,583.41 |
| HCO₃ | 156.80 |
| SO₄ | 11,368.63 |
| Cl | 35,814.20 |
| Total Anions | 47,339.63 |
| TDS | 70,923.07 |

This permeate 130 is fed at a flow rate of 6.8 m³/hr to an electrodialysis unit 200 having an Acilyzer 25-300 electrodialyzer supplied by Astom Corporation. The calculated compositions of the resulting electrodialysis concentrate 220 and diluent 210 are shown below in Tables 4 and 5, respectively. The concentrate 220 is produced at a rate of 0.16 m³/hr, while the diluent 210 is produced at a rate of 6.64 m³/hr.

TABLE 4
Electrodialysis Concentrate 220 Composition
Ion content (ppm)

| | |
|---|---|
| Na | 94,761.00 |
| Ca | 366.00 |
| Mg | 209.00 |
| K | 3,197.00 |
| Total Cations | 98,533.00 |
| HCO₃ | 697.00 |
| SO₄ | 0.00 |
| Cl | 133,226.00 |
| Total Anions | 133,923.00 |
| TDS | 232,456.00 |

TABLE 5
Electrodialysis Diluent 210 Composition
Ion content (ppm)

| | |
|---|---|
| Na | 6,658.50 |
| Ca | 80.27 |
| Mg | 132.50 |
| K | 121.30 |
| Total Cations | 6,992.57 |
| HCO₃ | 67.53 |
| SO₄ | 0.00 |
| Cl | 11,364.00 |
| Total Anions | 11,431.53 |
| TDS | 18,424.10 |

From the electrodialysis concentrate 220 composition shown in Table 4, it is clear that the present invention may be used to produce sodium chloride brine having more than 230,000 ppm total dissolved salts and less than 700 ppm divalent ions. Such brine would have to undergo an additional purification (deionization) step to be fed into a chlor-alkali cell.

The diluent 210 from the electrodialysis unit 200 is then fed into reverse osmosis unit 300 equipped with Filmtech XLE4040 membranes (thin polyamide film by Dow Chemicals, USA). The unit is a two pass reverse osmosis system consisting of 3 stages in the first pass and a single stage in the second pass. The pressure applied in each of the 3 stages of the first pass is 21.66, 32.78 and 39.19 bars, respectively. The average flux in the first pass is 8.98 l/m²/hr through an active membrane area of 533.43 m². The applied pressure in the single pass of the second stage is 9.66 bars. The average flux of the second pass is 14.33 l/m²/hr through an active membrane area of 290.96 m². The reverse osmosis unit 300 is calculated to produce potable water 320 at a rate of 4.65 m³/hr and a reverse osmosis retentate 310 at a rate of 1.99 m³/hr. The compositions calculated for the potable water 320 and the retentate 310 are shown below in Tables 6 and 7, respectively.

TABLE 6
Potable Water 320 Composition
Ion content (ppm)

| | |
|---|---|
| Na | 171.20 |
| Ca | 2.04 |
| Mg | 3.42 |
| K | 2.99 |
| Total Cations | 179.65 |
| HCO₃ | 1.71 |
| SO₄ | 0.00 |
| Cl | 292.17 |
| Total Anions | 293.88 |
| TDS | 473.53 |

TABLE 7
Reverse Osmosis Retentate 310 Composition
Ion content (ppm)

| | |
|---|---|
| Na | 21,795.63 |
| Ca | 262.80 |
| Mg | 433.70 |
| K | 397.50 |
| Total Cations | 22,889.63 |
| HCO₃ | 220.84 |
| SO₄ | 0.00 |
| Cl | 37,192.73 |
| Total Anions | 37,413.57 |
| TDS | 60,303.20 |

As can be seen from the composition in Table 6, the process of the present invention may be used to produce potable water 320 having a less than 600 mg/l TDS. Accordingly, the water palatability of the potable water 320 can be considered to be good in accordance with the World Health Organization Guidelines for Drinking-Water Quality, third edition, 2008.

As shown in FIG. 5, the retentate 310 can be recycled into the feed seawater stream to form a combined feed 90. The combined feed 90 has the composition shown in Table 8 below. The respective proportions of the seawater and the retentate 310 in the feed water stream 90 are 6.5 m³/hr and 1.99 m³/hr.

TABLE 8
Combined Feed 90 Composition
Ion content (ppm)

| | |
|---|---|
| Na | 13,161.24 |
| Ca | 392.14 |
| Mg | 1,053.10 |
| K | 277.11 |
| Total Cations | 14,883.58 |
| HCO₃ | 128.47 |
| SO₄ | 1,729.84 |
| Cl | 23,341.84 |
| Total Anions | 25,200.15 |
| TDS | 40,083.72 |

The combined feed is fed as feed water stream 90 at a rate of 8.49 m³/hr into the nanofiltration unit 100. The calculated compositions of the permeate 130 and the retentate 120 from the nanofiltration unit 100 are shown below in Tables 9 and 10, respectively. As in the case of the initial cycle through the process using seawater as the feed water stream 90, it is calculated that the permeate 130 will be produced at a rate of 6.8 m³/hr, while the retentate 120 will be produced at a rate of 1.69 m³/hr.

TABLE 9
Nanofiltration Permeate 130 Composition
Ion content (ppm)

| | |
|---|---|
| Na | 11,516.41 |
| Ca | 24.14 |
| Mg | 65.44 |
| K | 242.86 |
| Total Cations | 11,848.85 |
| HCO₃ | 110.48 |
| SO₄ | 0.00 |
| Cl | 20,485.73 |
| Total Anions | 20,596.21 |
| TDS | 32,445.06 |

TABLE 10
Nanofiltration Retentate 120 Composition
Ion content (ppm)

| | |
|---|---|
| Na | 19,872.00 |
| Ca | 1,907.30 |
| Mg | 5,123.05 |
| K | 481.83 |
| Total Cations | 27,321.18 |
| HCO₃ | 203.64 |
| SO₄ | 8,856.64 |
| Cl | 35,122.03 |
| Total Anions | 44,182.31 |
| TDS | 71,503.49 |

This permeate 130 is fed at a rate of 6.8 m³/hr to the electrodialysis unit 200. The calculated compositions of the resulting electrodialysis concentrate 220 and diluent 210 are shown below in Tables 11 and 12, respectively. It is calculated that the concentrate 220 is produced at a rate of 0.16 m³/hr, while the diluent 210 is produced at a rate of 6.64 m³/hr.

TABLE 11
Electrodialysis Concentrate 220 Composition
Ion content (ppm)

| | |
|---|---|
| Na | 118,537.44 |
| Ca | 99.46 |
| Mg | 101.13 |
| K | 3,697.42 |
| Total Cations | 122435.45 |
| HCO₃ | 45.94 |
| SO₄ | 0.00 |
| Cl | 183,029.24 |
| Total Anions | 183,075.18 |
| TDS | 305,510.63 |

TABLE 12
Electrodialysis Diluent 210 Composition
Ion content (ppm)

| | |
|---|---|
| Na | 8,143.62 |
| Ca | 21.66 |
| Mg | 63.96 |
| K | 134.80 |
| Total Cations | 8364.04 |
| HCO₃ | 247.43 |
| SO₄ | 0.00 |
| Cl | 15,344.60 |
| Total Anions | 15,592.03 |
| TDS | 23,956.07 |

From the electrodialysis concentrate 220 composition shown in Table 11, it is clear that the present invention may be used to produce sodium chloride brine having over 305,000 ppm total dissolved salts and less than 250 ppm divalent ions. Thus, this embodiment of the present invention may be used to produce sodium chloride brine suitable for being directly fed into a chlor-alkali membrane cell without the need for an additional deionization step.

In alternative, the electrodialysis concentrate 220 of this embodiment may be used as the sodium chloride brine precursor in processes for the production of Sodas ash (Sodium carbonate and Sodium bicarbonate), for example in the Solvay process.

The diluent 210 from the electrodialysis unit 200 is fed into the reverse osmosis unit 300, which is the same two pass osmosis system as the unit 300 described above, and operated using the same parameters. This reverse osmosis unit 300 produces a reverse osmosis permeate 340 (see the broken line in FIG. 5) at a rate of 4.648 m³/hr and a reverse osmosis retentate 310 at a rate of 1.99 m³/hr. The compositions calculated for the permeate 340 and the retentate 310 are shown below in Tables 13 and 14, respectively.

TABLE 13
Reverse Osmosis Permeate 340 Composition
Ion content (ppm)

| | |
|---|---|
| Na | 2,298.80 |
| Ca | 0.00 |
| Mg | 0.00 |
| K | 22.60 |
| Total Cations | 2,321.40 |
| HCO₃ | 259.76 |
| SO₄ | 0.00 |
| Cl | 5,974.89 |
| Total Anions | 6,234.65 |
| TDS | 8,556.05 |

TABLE 14
Reverse Osmosis Retentate 310 Composition
Ion content (ppm)

| | |
|---|---|
| Na | 21,794.78 |
| Ca | 72.20 |
| Mg | 213.20 |
| K | 396.67 |
| Total Cations | 22,476.85 |
| HCO₃ | 220.80 |
| SO₄ | 0.00 |
| Cl | 37,191.88 |
| Total Anions | 37,412.68 |
| TDS | 59,889.53 |

In some embodiments not illustrated in FIG. 5, the permeate 340 may be discharged into the feed water source 330 or fed to a further brackish water reverse osmosis unit (not shown) in order to recover potable water. The retentate 310 is recycled into the seawater input stream to obtain the feed water stream 90.

### Example 2

FIG. 6 illustrates the process flow diagram for Example 2.

In accordance with the process illustrated in FIG. 5, the feed water for this Example is seawater having the composition shown in Table 15 and an SDI of less than 1.5. The feed water source 330 in this Example is the sea.

TABLE 15
Seawater Composition
Ion content (ppm)

| | |
|---|---|
| Na | 10,500.00 |
| Ca | 432.00 |
| Mg | 1,244.00 |
| Ion content (ppm) | |
| K | 240.00 |
| Total Cations | 12,416.00 |
| HCO₃ | 100.00 |
| SO₄ | 2,263.00 |
| Cl | 19,072.80 |
| Total Anions | 21,435.80 |
| TDS | 33,851.80 |

The seawater is fed as feed water stream 90 at a rate of 8.49 m³/hr into a nanofiltration unit 100 in accordance with the nanofiltration unit 100 described above in Example 1. The calculated composition of the permeate 130 from the nanofiltration unit 100 is shown below in Table 16.

TABLE 16
Nanofiltration Permeate 130 Composition
Ion content (ppm)

| | |
|---|---|
| Na | 9,207.00 |
| Ca | 88.83 |
| Mg | 135.37 |
| K | 210.00 |
| Total Cations | 9,641.20 |
| HCO₃ | 85.85 |
| SO₄ | 0.00 |
| Cl | 14,911.00 |
| Total Anions | 14,996.85 |
| TDS | 24,638.05 |

The retentate 120 of the nanofiltration unit 100 is calculated to be emitted from the second nanofiltration device 102 at a rate of 1.69 m³/hr, and its calculated composition is shown below in Table 17.

TABLE 17
Nanofiltration Retentate 120 Composition
Ion content (ppm)

| | |
|---|---|
| Na | 15,869.56 |
| Ca | 1,853.56 |
| Mg | 5,183.14 |
| K | 362.69 |
| Total Cations | 23,268.95 |
| HCO₃ | 158.74 |
| SO₄ | 11646.53 |
| Cl | 36221.90 |
| Total Anions | 48,027.17 |
| TDS | 71,296.12 |

This permeate 130 is fed at a flow rate of 6.8 m³/hr to an electrodialysis unit 200. The electrodialysis unit 200 has three electrodialysis devices 201, 202, 203. Each electrodialysis device 201, 202, 203 is equipped with an Acilyzer 25-300 electrodialyzer supplied by Astom Corporation. The calculated compositions of the electrodialysis concentrate 212 and diluent 211 emitted from the first electrodialysis device 201 are shown below in Tables 18 and 19, respectively. The concentrate 212 is produced at a rate of 0.16 m³/hr, while the diluent 211 is produced at a rate of 6.64 m³/hr.

TABLE 18
First Electrodialysis Concentrate 212 Composition
Ion content (ppm)

| | |
|---|---|
| Na | 94,761.00 |
| Ca | 366.00 |
| Mg | 209.00 |
| K | 3,197.00 |
| Total Cations | 98,533.00 |
| HCO₃ | 697.00 |
| SO₄ | 0.00 |
| Cl | 133,226.00 |
| Total Anions | 133,923.00 |
| TDS | 232,456.00 |

TABLE 19
First Electrodialysis Diluent 211 Composition
Ion content (ppm)

| | |
|---|---|
| Na | 6,658.50 |
| Ca | 80.27 |
| Mg | 132.50 |
| K | 121.30 |
| Total Cations | 6,992.57 |
| HCO₃ | 67.53 |
| SO₄ | 0.00 |
| Cl | 11,364.00 |
| Total Anions | 11,431.53 |
| TDS | 18,424.10 |

The diluent 211 from the first electrodialysis device 201 is fed into the second electrodialysis device 202. The calculated compositions of the electrodialysis concentrate 222 and diluent 221 emitted from the second electrodialysis device 202 are shown below in Tables 20 and 21, respectively. It is calculated that the concentrate 222 is produced at a rate of 0.16 m³/hr, while the diluent 221 is produced at a rate of 6.48 m³/hr.

TABLE 20
Second Electrodialysis Concentrate 222 Composition
Ion content (ppm)

| | |
|---|---|
| Na | 68,535.00 |
| Ca | 330.70 |
| Mg | 204.77 |
| K | 1,846.73 |
| Total Cations | 70,917.20 |
| HCO₃ | 548.34 |
| SO₄ | 0.00 |
| Cl | 101,534.69 |
| Total Anions | 102,083.03 |
| TDS | 173,000.23 |

TABLE 21
Second Electrodialysis Diluent 221 Composition
Ion content (ppm)

| | |
|---|---|
| Na | 4,953.70 |
| Ca | 77.60 |
| Mg | 131.17 |
| K | 78.70 |
| Total Cations | 5,241.17 |
| HCO₃ | 55.55 |
| SO₄ | 0.00 |
| Cl | 9,151.23 |
| Total Anions | 9,206.78 |
| TDS | 14,447.95 |

The diluent 221 from the second electrodialysis device 202 is fed into the third electrodialysis device 203. The calculated compositions of the electrodialysis concentrate 232 and diluent 210 emitted from the third electrodialysis device 203 are shown below in Tables 22 and 23, respectively. It is calculated that the concentrate 232 is produced at a rate of 0.152 m³/hr, while the diluent 210 is produced at a rate of 6.33 m³/hr. The diluent 210 may be supplied from the electrodialysis unit 200 to a reverse osmosis unit 300 (not shown) in accordance with the process illustrated in FIG. 5 for further processing.

TABLE 22
Third Electrodialysis Concentrate 232 Composition
Ion content (ppm)

| | |
|---|---|
| Na | 50,988.02 |
| Ca | 319.71 |
| Mg | 202.72 |
| K | 1,198.20 |
| Total Cations | 52,708.65 |
| HCO₃ | 451.06 |
| SO₄ | 0.00 |
| Cl | 81,764.11 |
| Total Anions | 82,215.17 |
| TDS | 134,923.82 |

TABLE 23
Electrodialysis Diluent 210 Composition
Ion content (ppm)

| | |
|---|---|
| Na | 4,953.70 |
| Ca | 77.60 |
| Mg | 131.17 |
| K | 78.70 |
| Total Cations | 5,241.17 |
| HCO₃ | 55.55 |
| SO₄ | 0.00 |
| Cl | 9151.23 |
| Total Anions | 9,206.78 |
| TDS | 14,447.95 |

The concentrates 212, 222, 232 from each device 201, 202, 203 are combined together to form concentrate 220. The calculated composition of the electrodialysis concentrate 220 emitted from the electrodialysis unit 220 is shown below in Table 24. It is calculated that the concentrate 220 is produced at a rate of 0.472 m³/hr.

TABLE 24
Electrodialysis Concentrate 220 Composition
Ion content (ppm)

| | |
|---|---|
| Na | 71,774.45 |
| Ca | 339.13 |
| Mg | 205.54 |
| K | 2,095.60 |
| Total Cations | 74,414.72 |
| HCO₃ | 567.41 |
| SO₄ | 0.00 |
| Cl | 105,910.71 |
| Total Anions | 106,478.12 |
| TDS | 180,892.83 |

From the electrodialysis concentrate 220 composition shown in Table 24, it is clear that a series of electrodialysis devices may be used to maximize production of sodium chloride brine having more than 180,000 ppm total dissolved salts and less than 700 ppm divalent ions using the process of the present invention. The dashed lines in the schematic of FIG. 6 refer to the possibility to further purify the brine by feeding the diluent 210 into a reverse osmosis unit 300 of the same kind described in Example 1, and then recycling the reverse osmosis retentate 310 back into the nanofiltration unit 100. In some embodiments not illustrated in FIG. 5, the permeate 320 may be discharged into the sea or fed to a further brackish water reverse osmosis unit (not shown) in order to recover potable water.

The dashed lines in the schematic of FIG. 6 refer to the possibility to further purified the brine by feeding the diluent 210 into a reverse osmosis unit 300 of the same kind described in Example 1, and then recycling the reverse osmosis retentate 310 back into the nanofiltration unit 100. In some embodiments not illustrated in FIG. 5, the permeate 320 may be discharged into the sea or fed to a further brackish water reverse osmosis unit (not shown) in order to recover potable water.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavor to which this specification relates.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

Many modifications will be apparent to those skilled in the art without departing from the scope of the present invention.

1. A process for producing sodium chloride brine suitable for use in a sodium hydroxide production plant having a chlor-alkali membrane cell, said process comprising:
a) nanofiltering feed water containing dissolved sodium chloride to produce a permeate and a retentate, wherein the retentate comprises at least 85% of any divalent ions from the feed water; and
b) purifying the permeate to produce the sodium chloride brine suitable for use in a sodium hydroxide production plant having a chlor-alkali membrane cell, wherein step b) comprises electrodialyzing the permeate to produce a concentrate having a greater concentration of total dissolved salts and a smaller proportion of divalent ions than the permeate and a diluent comprising water and divalent ions separated from the permeate.

2. The process according to claim 1, wherein step b) further comprises:
treating the diluent using reverse osmosis to produce a reverse osmosis retentate; and
supplying at least part of the reverse osmosis retentate to step a).

3. The process according to claim 1, wherein step b) further comprises:
treating the concentrate using chemical precipitation and/or ion exchange to produce sodium chloride brine suitable for use in a sodium hydroxide production plant having a chlor-alkali membrane cell.

4. The process according to claim 2, wherein the concentrate is sodium chloride brine suitable for direct use in a chlor-alkali membrane cell.

5. The process according to claim 3, wherein the sodium chloride brine has at least 180,000 ppm total dissolved salts and less than 250 ppm divalent ions.

6. A system for producing sodium chloride brine suitable for use in a sodium hydroxide production plant having a chlor-alkali membrane cell, said system comprising:
a nanofiltration unit for nanofiltering feed water containing dissolved sodium chloride to produce a permeate and a retentate, wherein the retentate comprises at least 85% of any divalent ions from the feed water; and
a purification unit for receiving the permeate and producing the sodium chloride brine suitable for use in a sodium hydroxide production plant having a chlor-alkali membrane cell, wherein said purification unit comprises an electrodialysis unit for receiving the permeate and electrodialyzing the permeate to produce a concentrate having a greater concentration of total dissolved salts and a smaller proportion of divalent ions than the permeate and a diluent comprising water and divalent ions separated from the permeate.

7. The system according to claim 6, wherein the purification unit further comprises a reverse osmosis unit for receiving a diluent from the electrodialysis unit and treating the diluent to produce a reverse osmosis retentate; wherein the reverse osmosis unit is fluidly connected to a nanofiltration unit so that at least part of the reverse osmosis retentate is supplied to that nanofiltration unit and feed water comprises the reverse osmosis retentate.

8. The system according to claim 6, wherein the purification unit further comprises a chemical precipitation treatment unit and/or an ion exchange treatment unit.

9. A process for producing sodium hydroxide, said process comprising:
a) nanofiltering feed water containing dissolved sodium chloride to produce a permeate and a retentate, wherein the retentate comprises at least 85% of any divalent ions from the feed water;
b) purifying the permeate to produce a sodium chloride brine having at least 180,000 ppm total dissolved salts and less than 250 ppm divalent ions, wherein step b) comprises electrodialyzing the permeate to produce a concentrate having a greater concentration of total dissolved salts and a smaller proportion of divalent ions than the permeate and a diluent comprising water and divalent ions separated from the permeate; and
c) electrolyzing said sodium chloride brine in a chlor-alkali membrane cell to produce sodium hydroxide.

10. The process according to claim 9, wherein step b) further comprises:
treating the diluent using reverse osmosis to produce a reverse osmosis retentate; and
supplying at least part of the reverse osmosis retentate to step a).

11. The process according to claim 10, wherein the concentrate is the sodium chloride brine having at least 180,000 ppm total dissolved salts and less than 250 ppm divalent ions.

12. The process according to claim 9, wherein step b) further comprises:
treating the concentrate using chemical precipitation and/or ion exchange to produce the sodium chloride brine having at least 180,000 ppm total dissolved salts and less than 250 ppm divalent ions.

13. A system for producing sodium hydroxide, said system comprising:
a nanofiltration unit for nanofiltering feed water containing dissolved sodium chloride to produce a permeate and a retentate, wherein the retentate comprises at least 85% of any divalent ions from the feed water;
a purification unit for receiving the permeate and producing a sodium chloride brine having at least 180,000 ppm total dissolved salts and less than 250 ppm divalent ions, wherein said purification unit comprises an electrodialysis unit for receiving and electrodialyzing the permeate to produce a concentrate having a greater concentration of total dissolved salts and a smaller proportion of divalent ions than the permeate and a diluent comprising water and divalent ions separated from the permeate; and
a chlor-alkali membrane cell for receiving and electrolyzing said sodium chloride brine to produce sodium hydroxide.

14. The system according to claim 13, wherein the purification unit further comprises a reverse osmosis unit for receiving a diluent from the electrodialysis unit and treating the diluent to produce a reverse osmosis retentate; wherein the reverse osmosis unit is fluidly connected to a nanofiltration unit so that at least part of the reverse osmosis retentate is supplied to that nanofiltration unit and feed water comprises the reverse osmosis retentate.

15. The system according to claim 13, wherein the purification unit further comprises a chemical precipitation treatment unit and/or an ion exchange treatment unit.

16. A process for the commercial production of soda ash, said process comprising:
a) preparing a sodium chloride brine by:
nanofiltering feed water containing dissolved sodium chloride to produce a permeate and a retentate, wherein the retentate comprises at least 85% of any divalent ions from the feed water;
purifying the permeate to produce the sodium chloride brine having at least 180,000 ppm total dissolved salts and less than 250 ppm divalent ions, comprising electrodialyzing the permeate to produce a concentrate having a greater concentration of total dissolved salts and a smaller proportion of divalent ions than the permeate and a diluent comprising water and divalent ions separated from the permeate; and
b) using said sodium chloride brine in a soda ash production plant.

17. The process according to claim 16, wherein the production of soda ash in the soda ash production plant is performed according to the Solvay process.
